(19) United States
(12) Patent Application Publication
(10) Pub. No.: US 2001/0034783 A1
(43) Pub. Date: Oct. 25, 2001

(54) Method for transmitting information

(75) Inventor: Yoshimasa Kitamura, Hokkaido (JP)

Correspondence Address: LALOS & KEEGAN, Fifth Floor, 1146 Nineteenth Street, N.W., Washington, DC, 20036-3703, US

(73) Assignee: Hudson Soft Co. Ltd.

(21) Appl. No.: 09/837,216

(22) Filed: Apr. 19, 2001

(30) Foreign Application Priority Data
Apr. 19, 2000 (JP) 2000-118591

(51) Int. Cl. G06F 15/16

(52) U.S. Cl. 709/219; 709/203

(57) ABSTRACT

A method for transmitting information in which the transmission of image information by a mobile tool can be conducted is disclosed. An optional sending image A to be transmitted is drawn by calling images stored in a server 3 of the Internet onto a display 7 of a mobile telephone 1 and by composing them one another. The sending image A is stored in the server 3, and also is distributed from the server 3 to a mobile telephone 2 at the reception side. Since the sending image A is drawn using the storage capacity of the server 3 and distributed from the server 3, transmission of image information from a mobile telephone 1 becomes possible without increasing the storage capacity thereof.

### FIELD OF THE INVENTION

This invention relates to a method for transmitting information, and more particularly to, a method for transmitting information including image information and character data of large capacity from “i mode (a network connection service for a mobile telephone set developed by NTT)” of a mobile tool such as a mobile telephone set.

### BACKGROUND OF THE INVENTION

A mobile telephone set such as a miniaturized and multifunctional mobile telephone set has been developing rapidly in recent years. Particularly, what is called “i mode” which is capable of transmitting character information through the Internet has come to be widely used, and this gives the future of a mobile telephone set and the Internet great possibilities.

However, in a conventional “i mode” mobile telephone set, information which can be transmitted is restricted to character information of a limited capacity only, and it is impossible to append thereto and transmit therewith image information. This is because the storage capacity of memory within a mobile telephone set is limited, which restricts the possibilities of “i mode”. On the other hand, when the storage capacity of memory of a mobile telephone set is increased, the size of the mobile telephone set unfavorably becomes larger.

### SUMMARY OF THE INVENTION

Accordingly, it is an object of the invention to provide a method for transmitting information in which sending information including character information of large capacity as well as image information can be transmitted without increasing the storage capacity of a mobile tool.

According to the first aspect of the invention, a method for transmitting information between a transmitting terminal and a receiving terminal via the Internet comprises the steps of:

storing in a server on the Internet data constituting parts of a sending data to be transmitted from the transmitting terminal to the receiving terminal;

authoring the sending data on a display unit of the transmitting terminal by using the data stored;

storing the sending data in the Internet server;

distributing the data stored in the Internet server to the receiving terminal; and

displaying the data distributed on a display unit of the receiving terminal;

wherein the transmission of information between the transmitting terminal and the receiving terminal is conducted using a mobile tool such as a mobile telephone set as at least one terminal of the transmitting terminal and the receiving terminal.

According to the second aspect of the invention, a method for transmitting information between a transmitting terminal and a receiving terminal via the Internet comprises the steps of:

storing in a server on the Internet images constituting parts of a sending image to be transmitted from the transmitting terminal to the receiving terminal;

drawing the sending image on a display unit of the transmitting terminal by using the images stored;

storing the sending image in the Internet server;

distributing the image stored in the Internet server to the receiving terminal; and

displaying the image distributed on a display unit of the receiving terminal;

wherein the transmission of information between the transmitting terminal and the receiving terminal is conducted using a mobile tool such as a mobile telephone set as at least one terminal of the transmitting terminal and the receiving terminal.

According to the invention, information transmission is conducted in such manner that partial data or partial images for authoring a sending data or a sending image are stored using the storage capacity of a server provided on the Internet and that the sending data or the sending image authored by composing these partial data or partial images is transmitted via the server to a receiver side, so that the authoring and transmission of data or images become possible without increasing the storage capacity of memory of a mobile tool.

Accordingly, the storage capacity needed for a mobile tool is sufficient, if it is of the level to be able to display the sending data or the sending image on a display unit, thereby eliminating the need for a larger-sized mobile tool.

The sending image is usually drawn by composing the partial images stored on the server one another. However, it may be drawn by calling and only appointing a finished image stored on the server, or by first calling a finished image from the server and then replacing predetermined portions of the image with partial images called also from the server.

The transmission via the server can be conducted to either of single or plural addressees. It is also possible to save an image to be transmitted or an image which was transmitted to the server in the form of a file, or modify the image transmitted by the exchange of information between the receiver side and the server and send back such modified image to the sender side. Further, the tool needed for the addressee is not limited to a mobile telephone set, but it may be a home page on a personal computer.

### BRIEF DESCRIPTION OF THE DRAWINGS

The invention will be described in more detail in conjunction with the accompanying drawings, wherein:

FIGS. 1A and 1B are illustrations showing an embodiment of the information transmission method according to the invention, in which FIG. 1A shows the relation between transmitting and receiving terminals and a server and FIG. 1B shows the procedure of drawing and transmitting an image,

FIGS. 2A and B are illustrations showing an example of pixel in GIF image to draw a montage, in which FIG. 2A shows each part for a face and FIG. 2B shows the composition of each of the parts, and

FIG. 3 is an illustration showing another embodiment of the invention.

### DESCRIPTION OF THE PREFERRED EMBODIMENT

A preferred embodiment of the method for transmitting information according to the invention will be explained.

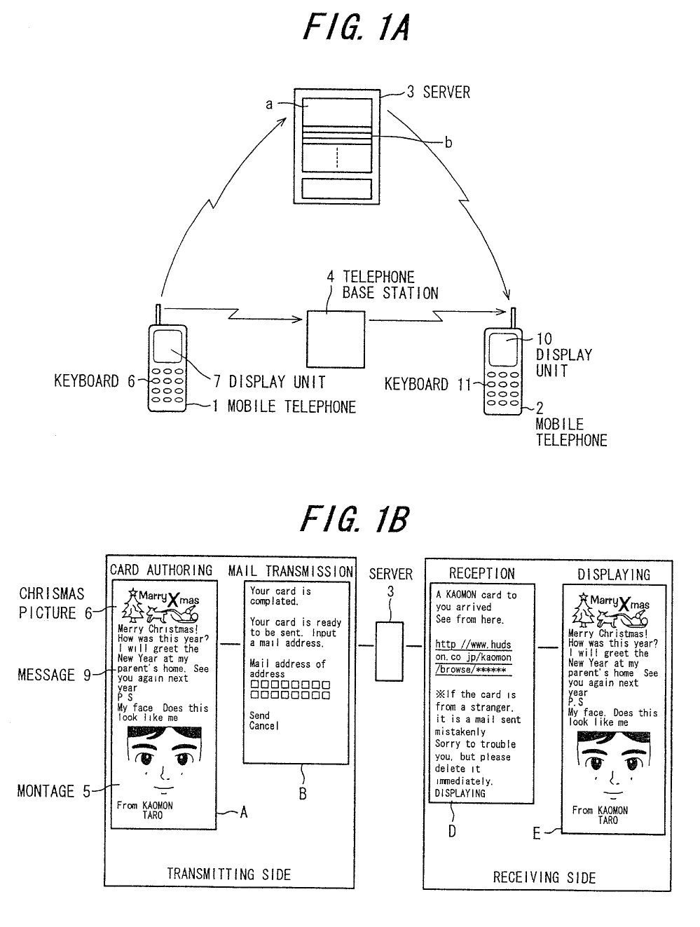

The embodiment in FIGS. 1A and 1B show an example to draw a montage of a face and transmit it as image information. A transmitter draws his montage by selecting optional parts from various parts of a face stored in a server and by composing these parts on the display unit of a mobile telephone set. Then, the transmitter stores the finished montage together with a message in the server, and makes the server distribute them to a mobile telephone set of a receiver side.

In FIG. 1A, reference numeral 1 indicates the mobile telephone set of the transmitter side, 2 indicates the mobile telephone set of the receiver side, 3 indicates the server on the Internet to be accessed by these mobile telephone sets, and 4 indicates a telephone base station.

The mobile telephone sets 1 and 2 each possesses a memory of small capacity (not shown) which only displays a montage which was drawn or transmitted. On the other hand, the server 3 possesses a domain (a) to store partial images, for example, various parts of a face, and domains (b) individually to store finished images authored, for example, montages of faces for each of transmitters and receivers.

FIG. 1B shows the procedure to draw and transmit a montage. At first, a montage of the transmitter's face 5 (hereafter indicated as “KAOMON <<face montage>>” in the figures) is drawn at the sending side. The montage 5 is drawn by selecting such parts as seem to fit most from various shapes stored in the domain (a) of the server for each part of a face such as a hairstyle, eyebrows and eyes.

These parts are selected by means of operating a keyboard 6 of the mobile telephone set 1 of the transmitter side, and then they are composed one another on the display unit 7, thereby forming an expected montage 5.

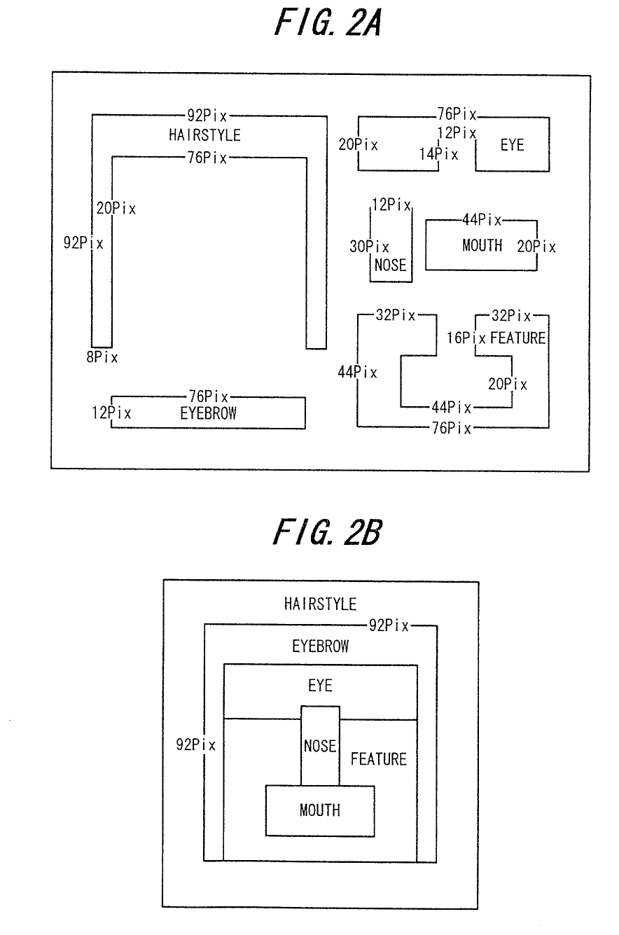

FIGS. 2A and 2B show an example of pixel in GIF image for the drawing of the montage S. As shown in FIG. 2A, six elements of a hairstyle, eyebrows, eyes, a nose, a mouth and features are formed with the pixel values indicated, and by composing these six elements as shown in FIG. 2B, the montage 5 is drawn.

In FIG. 1B, after the completion of the montage 5, a Christmas picture 8 etc. are called from various kinds of event pictures stored in the server 3 and added to the montage, and further a message 9 is inputted from the keyboard 6 to author a card of the picture A. When the authoring of the card is completed as mentioned above, an indication informing the completion of authoring of the card together with instructions to input a mail address are displayed on the display unit 7 as the picture B. By operating the keyboard in response to the instructions, transmission of the mail C is conducted. The content of the mail is stored in the server 3, and at the same time is distributed from the server 3 to the mobile telephone set 2 of the receiver side.

A termination call is made at the mobile telephone set 2. When the receiver opens the mail in response to the termination call, the picture of reception D is displayed on the display unit 10. Then, by accessing the address indicated, the picture E is displayed, by which the transmission of the image and the character information is completed. Meanwhile, in case that the receiver side does not open the mail, telephone communication via the telephone base station 4 maybe conducted to urge the receiver to open the mail.

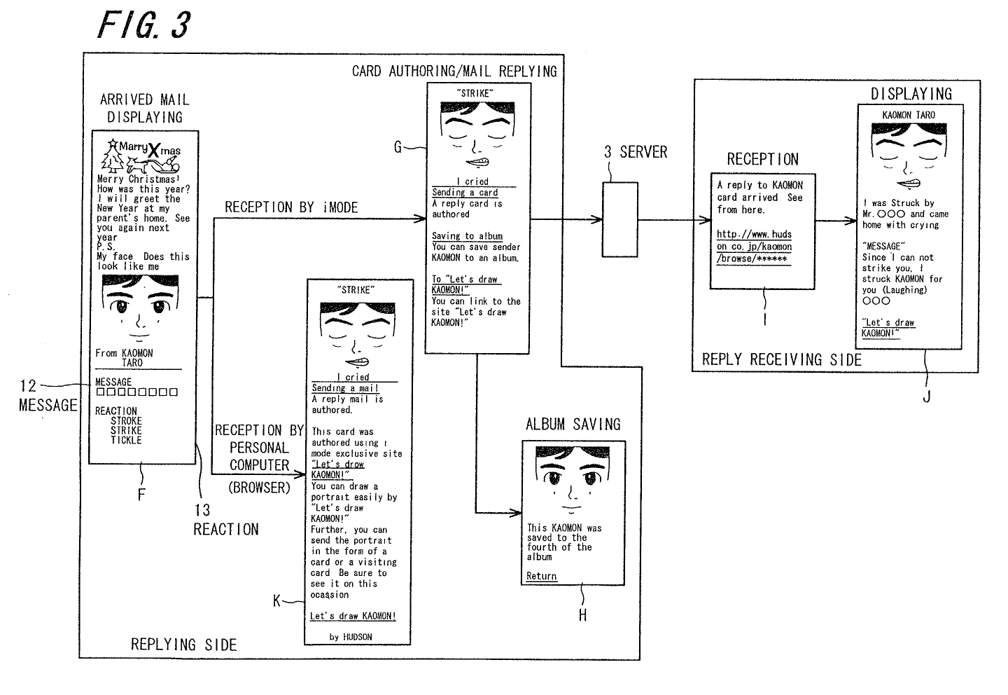

FIG. 3 shows an embodiment in which a procedure for replying from the receiver side is incorporated further to the embodiment of FIG. 1B. Namely, this embodiment is an example to transmit a reply mail by means of processing the picture of the arrived mail F which is displayed on the display unit 10 of the receiver side (replying side). Although the reception of the picture F is usually conducted with “i mode” of the mobile telephone set 2, a home page of a personal computer may also be used for the purpose.

In the case of “i mode”, when the receiver selects an item of reaction 13 in accordance with a message 12 appended to the picture F, the picture G is displayed. Then, the receiver authors a reply card by exchanging information with the server 3, and transmits it to the reply receiving side via the server 3, if necessary, after having conducted the album saving H to save the original montage to the domain (b) of the server 3 in FIG. 1A. On the mobile telephone set 1 of the reply receiving side, the picture of reception I is displayed, and by responding to the instructions indicated thereon, display of the picture J is performed.

In contrast, in the case that the reception of the picture F was conducted with a personal computer, when the receiver clicks an item of the reaction 13 in F, the picture K is displayed on the display unit, and an explanation of inviting to join members of montage authoring by “i mode” exclusive site is conducted. In this case, if the address of the transmitting side was inputted in the picture of the arrived mail F, the receiver can transmit a reply mail to the sender by conducting the same procedure as the pictures G to J in “i mode”.

In the embodiments mentioned above, the drawing of the image information, namely, “KAOMON (a face montage)” and the transmission and reception thereof using a server of the Internet is explained. However, the method can be applied not only to image information, but also to the authoring of character data of large capacity and the transmission and reception thereof. For example, such application may be conducted that Mr.A first stores a mail received from Mr.B including character data of large capacity in a server of the Internet, and next displays a part of the mail on the display unit of his mobile telephone set and modifies it, and then transfers such modified part along with the remaining part stored in the server to Mr.C. Thus, character data exceeding the storage capacity of memory of a mobile telephone set can be transmitted and received.

### ADVANTAGE OF THE INVENTION

As explained in the above, according to the method for transmitting information of this invention, a sending data or a sending image to be transmitted is authored by calling and composing on the display unit of the transmitting terminal the data or images which are stored in the Internet server, and the sending data or the sending image authored is stored in the server, and further by being distributed from the server, the sending data or the sending image is displayed on the display unit of the receiving terminal, and in these procedure, as at least one of the transmitting and receiving terminals, a mobile tool such as a mobile telephone set is used. Therefore, without increasing the capacity of memory, data transmission or image transmission by a mobile tool becomes possible.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within meets and bounds of the claims, or equivalence of such meets and bounds are therefore intended to be embraced by the claims.

What is claimed is:

1. A method for transmitting information between a transmitting terminal and a receiving terminal via the Internet comprising the steps of:
storing in a server on said Internet data constituting parts of a sending data to be transmitted from said transmitting terminal to said receiving terminal;
authoring said sending data on a display unit of said transmitting terminal by using said data stored;
storing said sending data in said Internet server;
distributing said data stored in said Internet server to said receiving terminal; and
displaying said data distributed on a display unit of said receiving terminal;
wherein said transmission of information between said transmitting terminal and said receiving terminal is conducted using a mobile tool such as a mobile telephone set as at least one terminal of said transmitting terminal and said receiving terminal.

2. A method for transmitting information between a transmitting terminal and a receiving terminal via the Internet comprising the steps of:
storing in a server on said Internet images constituting parts of a sending image to be transmitted from said transmitting terminal to said receiving terminal;
drawing said sending image on a display unit of said transmitting terminal by using said images stored;
storing said sending image in said Internet server;
distributing said image stored in said Internet server to said receiving terminal; and
displaying said image distributed on a display unit of said receiving terminal;
wherein said transmission of information between said transmitting terminal and said receiving terminal is conducted using a mobile tool such as a mobile telephone set as at least one terminal of said transmitting terminal and said receiving terminal.

3. A method for transmitting information, according to claim 2, wherein:
said step of drawing said sending image is conducted by calling a plurality of different ones of said images from said Internet server and composing them one another on said display unit of said transmitting terminal.

4. A method for transmitting information, according to claim 2, wherein:
said step of drawing said sending image is conducted with addition to said sending image of character information to be transmitted to said receiving terminal.

5. A method for transmitting information, according to claim 2, wherein:
said transmission of said information is conducted using a mobile tool such as a mobile telephone set as said transmitting terminal and said receiving terminal.

6. A method for transmitting information, according to claim 5, wherein:
said step of transmitting information includes that, in case that said mobile tool used as said receiving terminal does not display said sending image on its display unit, a telephone message to urge displaying of said image on said display unit is transmitted from said mobile tool as said transmitting terminal via a telephone line to said mobile tool as said receiving terminal.

7. A method for transmitting information, according to claim 2, wherein:
said step of displaying said sending image on said display unit of said receiving terminal includes a step to draw a replying image by calling said images from said Internet server and modifying a part of said sending image.
